(19) United States
(12) Patent Application Publication
(10) Pub. No.: US 2010/0265792 A1
(43) Pub. Date: Oct. 21, 2010

(54) STATIC MIXING DEVICE, AND PRODUCTION METHOD

(75) Inventor: Erwin Krumboeck, Ansfelden (AT)

Correspondence Address: COLLARD & ROE, P.C., 1077 NORTHERN BOULEVARD, ROSLYN, NY, 11576, US

(73) Assignee: Gruber & Co Group GmbH, Pettenbach (AT)

(21) Appl. No.: 12/735,026

(22) PCT Filed: Jun. 22, 2009
(86) PCT No.: PCT/AT2009/000247

§ 371 Date: Jun. 10, 2010

(30) Foreign Application Priority Data
Jun. 26, 2008 (AT) A 1017/2008

(51) Int. Cl. B01F 5/06; B23H 9/00

(52) U.S. Cl. 366/336; 219/69.17

(57) ABSTRACT

A static mixing device is described, comprising a flow channel and mixing elements which are distributed over the cross section of the flow channel in the form of flow bodies arranged on a wall extending in the direction of flow and which are each delimited by one tapering deflecting surface which is inclined in relation to the wall and originates from a base extending transversally to the direction of flow and by two guide surfaces which protrude from the wall and which converge in an edge extending transversally to the channel axis on the side of the flow bodies which is opposite of the base. In order to provide advantageous mixing conditions for thermally sensitive plastic materials it is proposed that the flow bodies (6) arranged on the channel wall fill out the flow cross section in a projection in the direction of the channel axis (8), with the exception of the pass-through slits (13) between the flow edges (12) obtained between the guide surfaces (10) and the deflecting surface (9), and at least the flow edges (12) between the guide surfaces (10) and the deflecting surface (9) of the flow bodies (6) are rounded off.

### 1. FIELD OF THE INVENTION

The invention relates to a static mixing device, comprising a flow channel and mixing elements which are distributed over the cross section of the flow channel in the form of flow bodies arranged on a wall extending in the direction of flow and which are each delimited by one tapering deflecting surface which is inclined in relation to the wall and originates from a base extending transversally to the direction of flow and by two guide surfaces which protrude from the wall and which converge in an edge extending transversally to the channel axis on the side of the flow bodies which is opposite of the base.

### 2. DESCRIPTION OF THE PRIOR ART

A molten plastic strand with a temperature distribution which is uneven over the cross section is obtained especially in connection with double-screw extruders during the extrusion of plastic, leading among other things to different wall thicknesses of plastic profiles which are formed with the help of shaping nozzles from said molten strand. For this reason, static mixing devices of different configuration are preferably used, which are to ensure temperature compensation. Conventional mixing devices used for this purpose comprise deflecting surfaces protruding into the flow path of the plastic strand which despite different possibilities for configuration each intend to provide a deflection of the melt transversally to the direction of flow in order to ensure the desired temperature compensation over the cross section of the molten plastic strand. These deflecting surfaces in the form of guide surfaces additionally lead to a turbulence supporting the mixing. However, this leads to the likelihood of local damage to the plastic as a result of longer dwell times for thermally sensitive plastic materials, e.g. on the basis of polyvinyl chloride.

In order to mix two fluids with one another it is further known (EP 0 619 134 B1) to use mixing elements in the form of flow bodies which are arranged on either side of a separating wall provided in the flow channel between the fluids to be mixed and each consist of a deflecting surface and two lateral guide surfaces which run apart from an edge protruding from the separating wall in the direction of the channel axis in a diverging manner up to a base for the deflecting surface aligned transversally to the direction of flow, with the deflecting surface rising from this base against the edge between the two guide surfaces. The flow bodies are thus delimited by triangular guide surfaces and a triangular deflecting surface, between which and the guide surfaces one flow edge each is obtained, which each ensure an oppositely direct formation of eddies in the fluid, irrespective of whether the flow against the flow bodies occurs from the side of the edge between the two lateral guide surfaces or from the side of the base of the deflecting surface, so that a thorough turbulence of the two fluids occurs in the outflow region of the flow body in continuation of the separating wall ending with the flow bodies. In order to advantageously utilize this effect, an annular flow channel with a separating wall ring is preferably inserted, with the flow bodies being arranged in a distributed manner over its circumference, which occurs in such a way that the flow bodies are arranged staggered on the one side of the separating wall ring opposite of the flow bodies on the opposite separating wall side, which not only enables a superposition of turbulence following the annular separating wall, but also avoids higher pressure losses. Due to the desired turbulence of the fluids to be mixed, such static mixing devices are not suitable for mixing thermally sensitive plastic melts such as those on the basis of polyvinyl chloride.

### SUMMARY OF THE INVENTION

The invention is thus based on the object of providing a mixing device which ensures good temperature compensation over the flow cross section of extruded plastic strands, especially on the basis of polyvinyl chloride, without needing to fear any local thermal overstressing of the plastic strand.

Based on a static mixing device of the kind mentioned above, the invention achieves the problem to be solved in such a way that the flow bodies arranged on the channel wall fill out the flow cross section in a projection in the direction of the channel axis, with the exception of the pass-through slits between the flow edges obtained between the guide surfaces and the deflecting surface, and at least the flow edges between the guide surfaces and the deflecting surface of the flow bodies are rounded off.

As a result of the deflecting surfaces preferably rising in the direction of flow, the molten plastic strand is deflected towards the channel axis, which leads to a displacement radially to the outside for the partial flows extending in the region of the pass-through slits between the flow bodies, so that a respective mixture over the flow cross section and thus a substantial temperature compensation is obtained. As a result of the rounded portion of at least the flow edges between the guide surfaces and the deflecting surface of the flow bodies, a laminar flow of the molten plastic strand can be maintained since the guide surfaces prevent dead spaces of the flow, which guide surfaces are adjacent to the deflecting surface along the pass-through slits and intersect with a substantially radially extending edge in the region of the individual flow bodies, and delimit a flow path continually expending in the direction of flow together with the opposite guide surfaces of the respectively adjacent flow bodies, in which path other partial flows are subjected to a radial displacement to the outside in the partial flows guided to the inside along the deflecting surface. Since the flow bodies fill out the flow cross section of the flow channel in a project in the direction of the channel axis with the exception of pass-through slits, substantially the entire flow cross section of the molten plastic strand is captured by the mixing elements, representing a far from inconsiderable precondition for a radial displacement of partial flows for the purpose of a substantial temperature compensation over the cross section of the plastic strand. Although the flow from the base of the deflecting surface of the flow bodies against the mixing elements is preferred, a flow in the opposite direction is also possible because comparable mixing effects are obtained in the through-flow of the mixing device in the opposite direction as a result of the laminar flow conditions.

Although the mixing device is substantially independent of the flow cross section of the flow channel, especially advantageous mixing conditions are obtained when the flow channel is arranged in a circular-cylindrical way, with the deflecting surfaces of the flow body being disposed on a conical surface with an axis of the cone coinciding with the channel axis, so that a transition from a circular flow cross section to the flow channel of the mixing device is obtained, which offers little obstruction to the flow of the molten plastic strand, thus having an advantageous effect on the pressure requirements for the mixing device. Especially simple constructional conditions are obtained in this connection when the flow bodies are arranged in a rotational-symmetrical manner about the channel axis, leading to symmetrical mixing conditions. If non-symmetrical temperature distributions are expected over the cross section of the plastic strand, it is possible to provide a non-symmetrical distribution of the flow bodies that takes such non-symmetrical temperature distribution into account or a different arrangement of the pass-through slits between the individual flow bodies.

Especially simple production conditions are obtained for static mixing devices with a flow channel and with mixing elements which are distributed over the cross section of the flow channel, are provided in the form of flow bodies arranged on a wall extending in the direction of flow, and are each delimited by a tapering deflecting surface which extends in an inclined manner in relation to the wall and originates from a base extending transversally to the direction of flow and by two guide surfaces which protrude from the wall and converge in an edge extending transversally to the channel axis on the side of the flow bodies opposite of the base, such that a solid base body which has the external shape of the flow channel is machined in a random sequence step by step, with said steps comprising the provision of axial slits which intersect each other in the axis of the base body, extend up to the inside surface of the flow channel and separate the flow bodies from one another in the circumferential direction and the production of the deflecting surfaces on the one hand with the help of an eroding wire which is fixed with one end in the axis of the base body and is guided along the face-side boundary of the inside surface of the flow channel, and the guide surfaces on the other hand also with the help of an eroding wire which is fixed with its one end in the respective axial slit on the inside surface of the flow channel in the region of the deflecting surfaces and is guided along the edge of the respective guide surfaces which extends transversally to the channel axis. When the eroding wire for the shaping of the deflecting surfaces which is fixed in the axis of the base body is guided along the face-side boundary of the inside surface of the flow channel, sector-shaped conical sections are severed from the base body which is subdivided in a star-shaped manner by the axial slits, with the remaining hollow conical surfaces forming the deflecting surfaces of the flow bodies. The guide surfaces which delimit these flow bodies on the side opposite of the deflecting surfaces in the direction of flow can be machined in a similarly simple manner with the help of eroding wires, in that theses eroding wires which are fixed on the inside wall of the flow channel in the respective axial slit in the region of the deflecting surfaces are guided along the edge between the deflecting surfaces and then along the face-side inside circumference of the flow channel. The edges between the guide surfaces of the individual flow bodies preferably lie in a plane which is normal to the axis of the base body, which is not mandatory however.

### BRIEF DESCRIPTION OF THE DRAWINGS

The drawings show the subject matter of the invention by way of example, wherein:

FIG. 1 shows a top view in the direction of flow of a static mixing device in accordance with the invention;

FIG. 2 shows this mixing device in a view against the direction of flow;

FIG. 3 shows a sectional view along the line III-III of FIG. 1;

FIG. 4 shows a sectional view along the line IV-IV of FIG. 1;

FIG. 5 shows a flow body in a perspective view, and

FIG. 6 shows a sectional view through a flow body along the line VI-VI of FIG. 1.

### DESCRIPTION OF THE PREFERRED EMBODIMENT

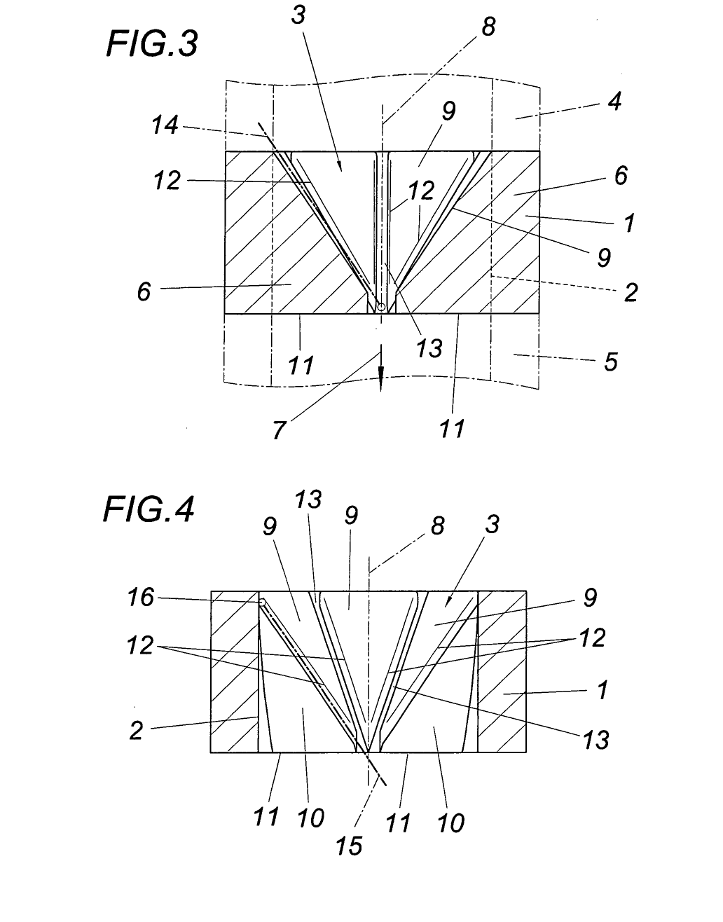

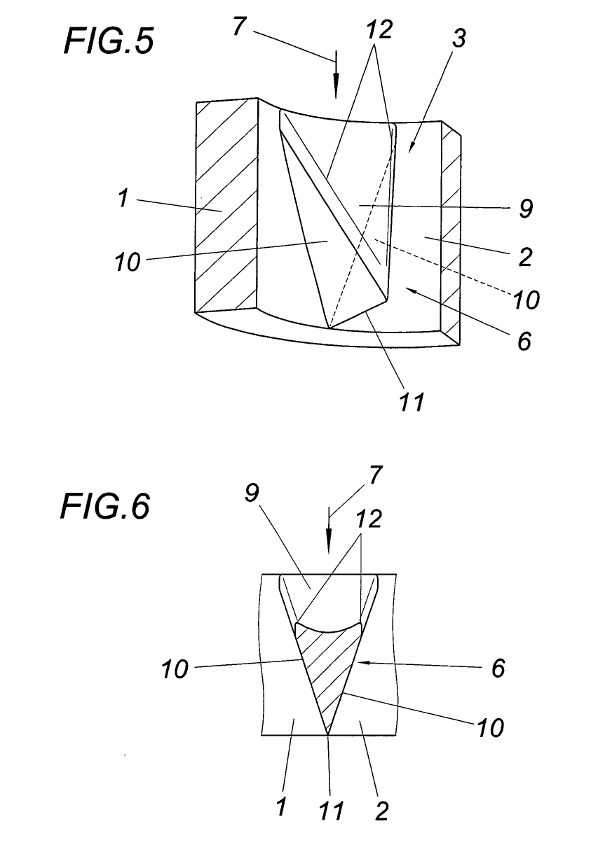

The illustrated static mixing device has a circular-cylindrical jacket 1, the inside surface 2 of which forms a flow channel 3 for a molten plastic strand, especially on the basis of polyvinyl chloride, which is supplied and discharged via circular-cylindrical conduits 4, 5, as is indicated in FIG. 3 with the dot-dash line. Mixing elements protrude into the flow channel 3 from the inside surface 2 of jacket 1. These mixing elements have the shape of flow bodies 6, of which one is shown in closer detail in FIGS. 5 and 6. This illustration shows that the flow bodies 6, according to the direction of flow 7 chosen in the embodiment which is not mandatory, comprise a deflecting surface 9 which is inclined from a base extending transversally to the direction of flow 7 towards the axis 8 of the flow channel 3 and two lateral guide surfaces 10 which converge into one edge 11 protruding radially from the inside surface 2. The flow edges 12 obtained between the guide surfaces 10 and the deflecting surface 9 are rounded off, as is shown especially in FIG. 6.

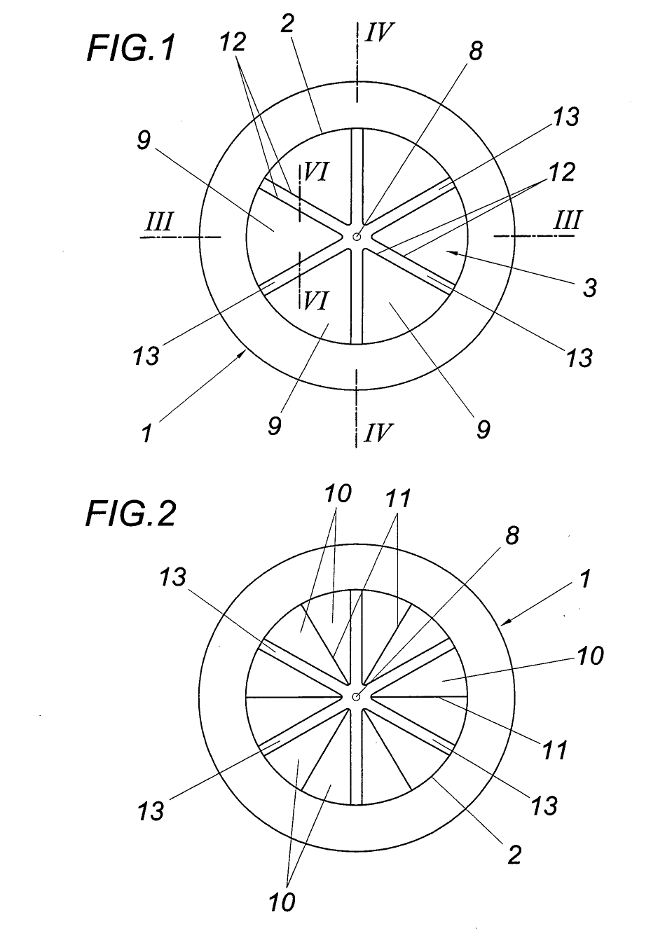

FIGS. 1 and 2 show that the flow bodies 6 substantially fill out the flow cross section in a projection in the direction of the channel axis 8 and merely leave the pass-through slits 13 between themselves. As a result of the rotational-symmetrical arrangement of the flow bodies 6 in relation to the axis 8 of the flow channel 3, the narrowest passage between the flow bodies 6 is obtained between the rounded flow edges 12 of adjacent mixing elements. From this narrowest passage cross section, the flow paths expand continually between the guide surfaces 10 which diverge in the direction of flow 7 until the full circular cross section of the flow channel 3 has been reached again on the outlet side.

On the basis of the illustrated arrangement of the flow bodies 6, a molten plastic strand which is supplied via conduit 4 and is circular in its cross section is deflected in the regions meeting the deflecting surfaces 9 along said deflecting surfaces 9 against the axis 8 of the flow channel 3 in order to flow through the pass-through slits 13 between the flow bodies 6 in a radially inwardly offset manner with respect to the impingement region. The strand regions displaced towards the channel axis 8 cause other strand regions to be displaced radially to the outside within the diverging flow sections obtained after the narrowest points of the pass-through slits 13, leading to a mixture of the plastic strand over its cross section and thus a substantial temperature compensation. As a result of the rounded flow edges 12 and the flow sections expanding continually after these flow edges, a laminar flow can be ensured within the mixing device, representing an important precondition in order to enable the mixing of thermally sensitive plastic strands like such on the basis of polyvinyl chloride without any thermal overloading in sections. Moreover, the conveying pressure can remain within ranges that are permissible for these plastic materials.

The production of the illustrated mixing device is comparatively simple because the surfaces 9, 10 which delimit the flow bodies 6 can be produced from straight lines, so that the mixing device can be produced by electroerosion with the help of eroding wires from a solid base body forming the outside circumference of the flow channel. The cylindrical base body can be provided at first for this purpose with axial slits which correspond to the narrowest passage of the pass-through slits 13 and therefore intersect in the axis 8 of the flow channel 3. With the help of an eroding wire 14 which is tightly held according to FIG. 3 in the region of the one face side of the base body in the axis 8 of the flow channel 3 and extends through an axial slit up to the face-side inside circumference 2 on the opposite face side, a cone can be separated from the slit base body when the eroding wire 14 is guided along the face-side circle of the inside surface 2. The deflecting surfaces 9 disposed on a common conical surface are thus obtained between the axial slits. In order to form the guide surfaces 10 adjacent to the deflecting surfaces 9 in the direction of flow 7, the respective eroding wire 15 needs to be fixed in accordance with FIG. 4 in the region of the axial slits on the side opposite of the edges 11 in the region of the deflecting surfaces 9 on the inside surface 2 in order to be guided at first along the edge 11 between the guide surfaces 10 of a flow body 6 and then along the inside surface 2 of the flow channel 3 in the case of a progression from said fixed point 16 along the flow edge 12 to the axis 8. Although later bores for inserting the eroding wires 14 and 15 can be omitted by the incorporation of the axial slits in the solid base body, which can also be performed by electroerosion, the illustrated sequence of the machining steps is in no way necessary. The surfaces of the flow bodies 6 can be processed in any random sequence.

1. A static mixing device, comprising a flow channel and mixing elements which are distributed over the cross section of the flow channel in the form of flow bodies arranged on a wall extending in the direction of flow and which are each delimited by one tapering deflecting surface which is inclined in relation to the wall and originates from a base extending transversally to the direction of flow and by two guide surfaces which protrude from the wall and which converge in an edge extending transversally to the channel axis on the side of the flow bodies which is opposite of the base, wherein the flow bodies (6) arranged on the channel wall fill out the flow cross section in a projection in the direction of the channel axis (8), with the exception of the pass-through slits (13) between the flow edges (12) obtained between the guide surfaces (10) and the deflecting surface (9), and at least the flow edges (12) between the guide surfaces (10) and the deflecting surface (9) of the flow bodies (6) are rounded off.

2. A static mixing device according to claim 1, wherein flow channel (3) is arranged in a circular-cylindrical way and the deflecting surfaces (9) of the flow bodies (6) are disposed on a conical surface with an axis of the cone coinciding with the channel axis (8).

3. A static mixing device according to claim 1, wherein the flow bodies (6) are arranged in a rotational-symmetrical way about the channel axis (8).

4. A method for producing a static mixing device, comprising a flow channel and mixing elements which are distributed over the cross section of the flow channel in the form of flow bodies arranged on a wall extending in the direction of flow which are each delimited by a tapering deflecting surface which extends in an inclined manner in relation to the wall and originates from a base extending transversally to the direction of flow and by two guide surfaces which protrude from the wall and converge in an edge extending transversally to the channel axis on the side of the flow bodies opposite of the base, wherein a solid base body which has the external shape of the flow channel (3) is machined in a random sequence step by step, with said steps comprising the provision of axial slits which intersect each other in the axis (8) of the base body, extend up to the inside surface (2) of the flow channel (3) and separate the flow bodies (6) from one another in the circumferential direction and the production of the deflecting surfaces (9) on the one hand with the help of an eroding wire (14) which is fixed with one end in the axis (8) of the base body and is guided along the face-side boundary of the inside surface (2) of the flow channel (3), and the guide surfaces (10) on the other hand also with the help of an eroding wire (15) which is fixed with its one end in the respective axial slit on the inside surface (2) of the flow channel (3) in the region of the deflecting surfaces (9) and is guided along the edge (11) of the respective guide surfaces (10) which extends transversally to the channel axis (8).
